(19) United States
(12) Patent Application Publication
(10) Pub. No.: US 2009/0242547 A1
(43) Pub. Date: Oct. 1, 2009

(54) COOKER AND METHOD FOR CONTROLLING THE SAME

(76) Inventors: Hee Suk ROH, Seoul (KR); Young Jun Lee, Seoul (KR); Yang Kyeong Kim, Seoul (KR); Byeong Wook Park, Seoul (KR)

Correspondence Address: KED & ASSOCIATES, LLP, P.O. Box 221200, Chantilly, VA, 20153-1200, US

(21) Appl. No.: 12/260,336

(22) Filed: Oct. 29, 2008

(30) Foreign Application Priority Data
Mar. 25, 2008 (KR) 10-2008-0027200

(51) Int. Cl. G05D 23/00

(52) U.S. Cl. 219/494

(57) ABSTRACT

A cooker and a method for controlling the cooker are provided. The cooker may include a heating source configured to generate heat, a detection sensor configured to detect a temperature of the heating source, and a controller configured to compare a current temperature of the heating source detected by the detection sensor with at least one control reference temperature so as to control an on/off operation of the heating source. Until the current temperature of the heating source reaches the control reference temperature, the controller controls the heating source to be kept in an on-state, and when the current temperature of the heating source exceeds the control reference temperature, the controller controls the heating source to be repeatedly turned on and off for a predetermined period of time or a predetermined number of times.

The present application claims priority under 35 U.S.C. 119 and 35 U.S.C. 365 to Korean Patent Application No. 10-2008-0027200, filed in Korea on Mar. 25, 2008, which is hereby incorporated by reference in its entirety.

### BACKGROUND

1. Field

A cooker and method for controlling the same are disclosed herein.

2. Background

Cookers and methods of controlling cookers are known. However, they suffer from various disadvantages.

### BRIEF DESCRIPTION OF THE DRAWINGS

Embodiments will be described in detail with reference to the following drawings in which like reference numerals refer to like elements, and wherein:

FIG. 1 is a perspective view of a cooker according to an embodiment;

FIG. 2 is a perspective view of a heater assembly according to an embodiment;

FIG. 3 is a block diagram of a cooker according to an embodiment;

FIG. 4 is a flowchart of a method for controlling a cooker according to an embodiment; and

FIG. 5 is a graph showing temperature variations of a heater and a temperature sensor while the cooker is controlled according to an embodiment.

### DETAILED DESCRIPTION

Cookers are home appliances used for cooking food using electricity or gas. Such a cooker may include a heating source that heats food, a detector that detects a temperature of a heating source, and a controller that controls the temperature of the heating source below a rated temperature based on a temperature detected by the detector.

In more detail, if a user selects a cooking mode, the controller operates the heating source. If the temperature of the heating source detected by the detector increases greater than a rated temperature, the controller turns off the heating source, and if the temperature of the heating source detected by the detector decreases below the rated temperature, the controller turns on the heating source. The controller repeats this on-off operation so that the heating source may be controlled at a temperature not greater than the rated temperature.

The rated temperature means a maximum temperature which the heating source can reach without damage. For example, if the heating source is a tube heater, the rated temperature is about 950° C. In this case, the controller may turn off the heating source when the temperature of the heating source exceeds 950° C. and turn on the heating source when the temperature of the heating source decreases below the rated temperature by 50° C., that is, below 900° C.

However, such a cooker has at least the following disadvantages.

As explained above, the heating source is operated until its temperature reaches the rated temperature. However, there can be a difference between the real temperature of the heating source and the temperature of the heating source detected by the detector. In other words, although the temperature of the heating source reaches the rated temperature, the detector can detect that the temperature of the heating source is below the rated temperature. In this case, the controller does not turn off the heating source although the real temperature of the heating source exceeds the rated temperature, and thus, the heating source may be damaged by overheat.

A cooker will now be described more fully with reference to the accompanying drawings, in which exemplary embodiments are shown.

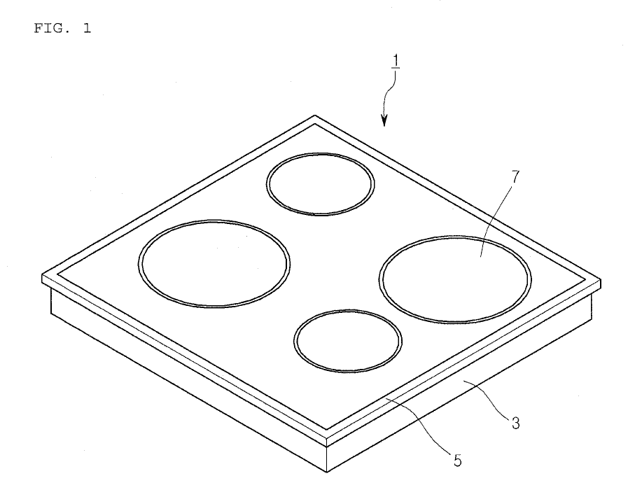

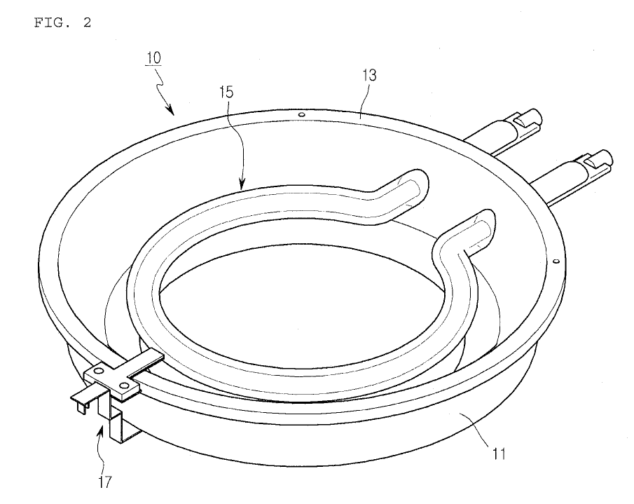

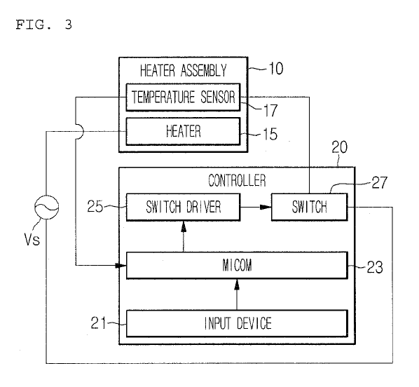

FIG. 1 is a perspective view of a cooker according to an embodiment. FIG. 2 is a perspective view of a heater assembly according to an embodiment. FIG. 3 is a block diagram of a cooker according to an embodiment.

Referring to FIG. 1, an electric hob 1, which is illustrated as an example of a cooker according to embodiments, may include a casing 3 and a plate 5. The casing 3 may have a flat hexahedron shape with an opened top. The casing 3 may accommodate a heating source, such as a heater assembly 10 (described later with refer reference to FIG. 2), and other components for operating the electric hob 1.

The plate 5 may be disposed on the opened top of the casing 3. A plurality of container seats 7 may be marked on the top plate 5 to indicate positions where a container containing food or other items to be heated or cooked may be placed.

Referring to FIG. 2, the heater assembly 10 disposed inside the casing 3 may be used as a heating source to heat a container placed on the container seat 7 of the plate 5. The heater assembly 10 may include a heater base 11, a reflector 13, a heater 15, and a temperature sensor 17.

In more detail, the heater base 11 may form a space in which the heater 15 may be installed. In this embodiment, the heater base 11 has a flat cylindrical shape with an opened top; however, other shapes and configurations may also be appropriate.

The reflector 13 may reflect heat generated by the heater 15. The reflector 13 may have a shape corresponding to a shape of the heater base 11, and may be disposed inside the heater base 11 in a manner such that an outer surface of the reflector 13 makes contact with an inner surface of the heater base 11.

The heater 15 may be disposed inside the reflector 13. The heater 15 may be used to heat food or other items in a container placed on the container seat 7.

In this embodiment, a tube heater may be used as the heater 15. The tube heater may include an approximately horseshoe-shaped or Q-shaped tube and a filament disposed inside the tube. The tube may be formed of quartz, and the filament may be formed of carbon.

When power Vs is supplied to the filament from an external power source (shown in FIG. 3), the filament may be heated by electric resistance, so that the filament generates heat. If the tube is formed of quartz, the rated temperature of the tube may be about 950° C.

The temperature sensor 17 may be disposed at a rim of a top surface of the reflector 13. An end of the temperature sensor 17 may extend to the inside of the reflector 13 and may be close to the heater 15.

The temperature sensor 17 may be used to detect the temperature of the heater 15. In more detail, the temperature sensor 17 may be disposed at a periphery of the heater 15 to detect the temperature of the heater 15 indirectly. That is, the temperature of the heater 15 may be determined using a temperature measured by the temperature sensor 17 and a predetermined ratio.

For example, the temperature sensor 17 may be one of a negative temperature coefficient (NTC) type sensor of which the resistance varies in reverse proportion to the temperature, and a positive temperature coefficient (PTC) type sensor of which the resistance varies in proportion to the temperature. The resistance of the temperature sensor 17 which varies with temperature may be transmitted to a controller 20 (described later with reference to FIG. 3).

Next, referring to FIG. 3, the controller 20 of the electric hob 1 may control operation thereof. The controller 20 may include an input device 21, a micro computer (micom) 23, a switch driver 25, and a switch 27.

The input device 21 may receive an operational signal for operating the electric hob 1. For example, the input device 21 may receive an operation start/stop signal to turning on/off the electric hob 1.

The micom 23 may control operation of the heater assembly 10 according to the operation signal input through the input device 21. Further, the micom 23 may receive resistance variations of the temperature sensor 17 according to temperature variations of the heater 15 and determine the temperature (hereinafter, referred to as a current temperature Tp of the heater 15). Then, the micom 23 may compare the current temperature Tp of the heater 15 with first and second control reference temperatures T1 and T2, and control the switch driver 25 to turn on the switch 27 or repeatedly turn on/off the switch 27.

More particularly, if the micom 23 determines that the current temperature Tp of the heater 15 is not higher than the first control reference temperature T1, the micom 23 may control the switch driver 25 to turn on the switch 27. On the other hand, if the micom 23 determines that the current temperature Tp of the heater 15 is higher than the first control reference temperature T1, the micom 23 may control the switch driver 25 to repeatedly turning on/off the switch 27 for a predetermined period of time or a predetermined number of times.

At this time, if the micom 23 determines that the current temperature Tp of the heater 15 is equal to or higher than a preset first off-operation reference temperature T1a, the micom 23 may control the switch driver 25 to turn off the switch 27. On the other hand, if the micom 23 determines that the current temperature Tp of the heater 15 is equal to or lower than a preset first on-operation temperature T1b, the micom 23 may control the switch driver 25 to turn on the switch 27.

Next, if the controller 20 determines that the current temperature Tp of the heater 15 is not higher than the second control reference temperature T2, the controller 20 may control the switch driver 25 to turn on the switch 27. On the other hand, if the controller 20 determines that the current temperature Tp of the heater 15 is higher than the second control reference temperature T2, the controller 20 may control the switch driving unit 25 to repeatedly turn on/off the switch 27 for a predetermined period of time or a predetermined number of times.

At this time, if the controller 20 determines that the current temperature Tp of the heater 15 is equal to or higher than a preset second off-operation reference temperature T2a, the controller 20 may control the switch driver 25 to turn off the switch 27. On the other hand, if the controller 20 determines that the current temperature Tp of the heater 15 is equal to or lower than a preset second on-operation temperature T2b, the controller 20 may control the switch driver 25 to turn on the switch 27.

The first and second control reference temperatures T1 and T2 may be determined according to the rated temperature. The first off-operation reference temperature T1a and the first on-operation reference temperature T1b may be determined according to the first control reference temperature T1, and the second off-operation reference temperature T2a and the second on-operation reference temperature T2b may be determined according to the second control reference temperature T2.

Further, one of the first off-operation reference temperature T1a and the first on-operation reference temperature T1b may be equal to the first control reference temperature T1. Similarly, one of the second off-operation reference temperature T2a and the second on-operation reference temperature T2b may be equal to the second control reference temperature T2.

Furthermore, the second control reference temperature T2 may be equal to or lower than the rated temperature, and the first control reference temperature T1 may be lower than the second control reference temperature T2. For example, the first control reference temperature T1 may be 880° C., lower than the rated temperature, and the second control reference temperature T2 may be ˜950° C., equal to the rated temperature.

The first off-operation reference temperature T1a and the first on-operation reference temperature T1b may be ˜895° C. and ˜880° C., respectively, and the second off-operation reference temperature T2a and the second on-operation reference temperature T2b may be ˜950° C. and ˜936° C., respectively. However, it should be noted that the first control reference temperature T1, the second control reference temperature T2, the first off-operation reference temperature T1a, the first on-operation reference temperature T1b, the second off-operation reference temperature T2a, and the second on-operation reference temperature T2b are not limited to the above-listed temperature values.

The temperatures, such as the first control reference temperature T1 and the second control reference temperature T2, may be determined according to the rated temperature of the heater 15. That is, such temperatures may be determined according to a type of the heater 15.

As explained above, the resistance of the temperature sensor 17 may vary according to the temperature of the heater 15. Resistance variations of the temperature sensor 17 may be transmitted to the micom 23, and the micom 23 may determine the temperature of the temperature sensor 17 based on the resistance variations of the temperature sensor 17.

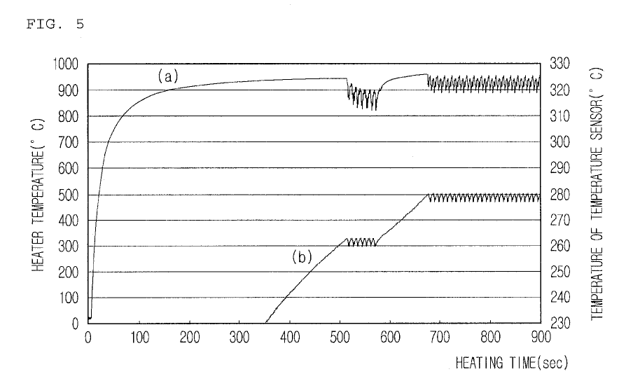

The temperature of the temperature sensor 17 may be lower than the temperature of the heater 15, and this temperature difference may be expressed using a temperature ratio. For example, when the current temperature Tp of the heater 15 is equal to the first control reference temperature T1 (e.g., ˜880° C.) or the second control reference temperature T2 (e.g., ˜950° C.), the temperature of the temperature sensor 17 may be determined to be equal to ˜260° C. or ˜280° C. See FIG. 5 and the discussion regarding FIG. 5 herein below.

When the current temperature Tp of the heater 15 is equal to the first off-operation reference temperature T1a (e.g., ˜895° C.), the first on-operation reference temperature T1b (e.g., ˜880° C.), the second off-operation reference temperature T2a (e.g., ˜950° C.), and the second on-operation reference temperature T2b (e.g., ˜936° C.), it may be determined that the temperature of the temperature sensor 17 is equal to ˜264° C., ˜260° C., ˜280° C., and ˜276° C., respectively. Again, see FIG. 5 and the discussion regarding FIG. 5 herein below.

The controller 20 may control the heater 15 based on the temperature of the temperature sensor 17. Therefore, in the following description, control operations will be explained based on the relationship of the temperature of the temperature sensor 17 with the first control reference temperature T1, the second control reference temperature T2, the first off-operation reference temperature T1a, the first on-operation reference temperature T1b, the second off-operation reference temperature T2a, and the second on-operation reference temperature T2b.

The switch driver 25 may turn on/off the switch 27 under the control of the micom 23. According to the turning on/off of the switch 27 by the switch driver 25, power Vs may be supplied to the heater 15 or not supplied to the heater 15 so that the on/off operation of the heater 15 is possible.

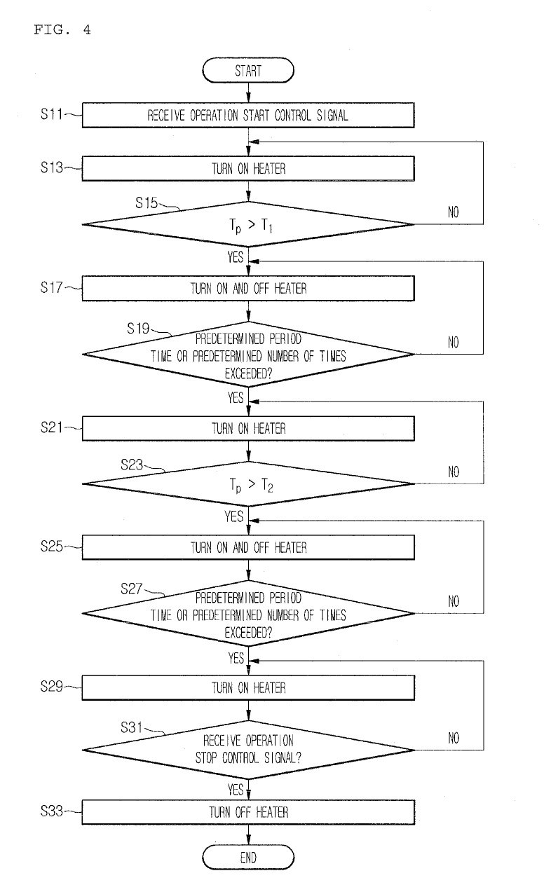

A method for controlling a cooker will now be described in detail with reference to the accompanying drawings, in which exemplary embodiments are shown. FIG. 4 is a flowchart of a method for controlling a cooker according to an embodiment, while FIG. 5 is a graph showing temperature variations of the heater 15 and the temperature sensor 17 while the cooker is controlled according to an embodiment.

Referring to FIG. 4, in step S11, the input device 21 receives an operation start control signal. Then, in step S13, the micom 23 may control the switch driver 25 to turn on the switch 27 so that the heater 15 is operated. In step S15, the micom 23 may compare a current temperature Tp of the heater 15 detected by the temperature sensor 17 in step S13, with a first control reference temperature T1.

If the micom 23 determines that the current temperature Tp of the heater 15 is higher than the first control reference temperature T1, the micom 23 may control the heater 15 so that the heater 15 may be repeatedly turned on and off, in step S17. The on/off operation of the heater 15 may be repeated in the same manner as that described above, and thus, a detailed description thereof will be omitted. In step S15, if it is determined that the current temperature Tp of the heater 15 is not higher than the first control reference temperature T1, the micom 23 may maintain the heater 15 in an on-state—that is, the heater 15 may be maintained in the same state as that in step S13.

In step S19, the micom 23 may determine whether the on/off operation of the heater 15 is repeated in step S17 for more than a predetermined period of time or more than a predetermined number of times. If the micom 23 determines that the on/off operation of the heater 15 is repeated for longer than the predetermined period of time or more than the predetermined number of times, the micom 23 may stop the repetition of the on/off operation of the heater 15 and maintain the heater 15 in the on-state, in step S21.

On the other hand, if the micom 23 determines that the on/off operation of the heater 15 is not repeated for longer than the predetermined period of time or more than the predetermined number of times, the procedure may go back to step S17 to continue repetition of the on/off operation of the heater 15.

While the heater 15 is turned on in step S21, the micom 23 may compare a current temperature Tp of the heater 15 detected by the temperature sensor 17 with a second control reference temperature T2, in step S23. If the micom 23 determines that the current temperature Tp of the heater 15 is higher than the second control reference temperature T2, the micom 23 may control the heater 15 so that the heater 15 is repeatedly turned on and off, in step S25. If the micom 23 determines that the current temperature Tp of the heater 15 is not higher than the second control reference temperature T2, the procedure may go back to step S21.

In step S27, the micom 23 may determine whether the on/off operation of the heater 15 is repeated for longer than a predetermined period of time or more than a predetermined number of times. If the micom 23 determines that the on/off operation of the heater 15 is repeated for longer than a predetermined period of time or more than a predetermined number of times, the micom 23 may stop the repetition of the on/off operation of the heater 15 and maintain the heater 15 in the on-state, in step S29. On the other hand, if the micom 23 determines that the on/off operation of the heater 15 is not repeated for longer than the predetermined period of time or more than the predetermined number of times, the procedure may go back to step S25 to continue repetition of the on/off operation of the heater 15.

In step S31, the micom 23 may determine whether the input device 21 receives an operation stop control signal. If the micom 23 determines that an operation stop control signal is input to the input device 21, the micom 23 may turn off the heater 15, in step S33. On the other hand, if the micom 23 determines that an operation stop control signal is not input to the input device 21, the procedure may go back to step S29 to maintain the heater 15 in the on-state.

Referring to FIG. 5, when the current temperature Tp of the heater 15 increases to a first control reference temperature T1 (e.g., ˜880° C.) after the heater 15 is turned on (referring to the line (a)), the temperature of the temperature sensor 17 increases linearly to about 260° C. corresponding to the first control reference temperature T1 (referring to the line (b)). If the current temperature Tp of the heater 15 increases greater than the first control reference temperature T1, the heater 15 may be repeatedly turned on/off. Then, the current temperature Tp of the heater 15 may fluctuate substantially between a first off-operation reference temperature T1a (e.g., ˜895° C.) and a first on-operation reference temperature T1b (e.g., ˜880° C.). Accordingly, the temperature of the temperature sensor 17 may fluctuate between about 264° C. corresponding to the first off-operation reference temperature T1a (˜895° C.) and about 260° C. corresponding to the first on-operation reference temperature T1b (˜880° C.).

If the heater 15 is kept in on-state after the repetition of the on/off operation of the heater 15, the current temperature Tp of the heater 15 may increase to a second control reference temperature T2 (e.g., ˜950° C.). Then, the temperature of the temperature sensor 17 may increase linearly to ˜280° C. corresponding to the second control reference temperature T2 (˜950° C.). Then, if the current temperature Tp of the heater 15 increases greater than the second control reference temperature T2 (˜950° C.), the heater 15 may be repeatedly turned on and off, and then the current temperature Tp of the heater 15 fluctuates substantially between a second off-operation reference temperature T2a (e.g., ˜950° C.) and a second on-operation reference temperature T2b (e.g., ˜936° C.). Accordingly, the temperature of the temperature sensor 17 fluctuates between about 280° C. corresponding to the second off-operation reference temperature T2a (˜950° C.) and about 276° C. corresponding to the second on-operation reference temperature T2b (˜936° C.).

As described above, each time the temperature of the heater 15 increases greater than the first control reference temperature T1 and the second control reference temperature T2, the heater 15 is repeatedly turned on and off for a predetermined period of time or a predetermined number of times. Therefore, the temperature of the heater 15 does not increase higher than the rated temperature (e.g., ˜950° C.) of the heater 15 so that the heater 15 may be prevented from being damaged by overheating.

In the above-described embodiments, the repetitive on/off operation of the heater is performed two times. That is, the repetitive on/off operation of the heater is performed each time the temperature of the heater increases higher than the first control reference temperature and the second control reference temperature. However, the scope of the present application is not limited thereto. That is, the repetitive on/off operation of the heater can be performed one, three, or more times.

Embodiments disclosed herein provide a cooker configured to heat food more safely, and a method for controlling the cooker.

In one embodiment disclosed herein, a cooker is provided. The cooker may include a heating source configured to generate heat, a detection sensor configured to detect a temperature of the heating source, and a control unit or controller configured to compare a current temperature of the heating source detected by the detection sensor with at least one control reference temperature so as to control an on/off operation of the heating source, wherein until the current temperature of the heating source reaches the control reference temperature, the control unit controls the heating source to be kept in an on-state, and when the current temperature of the heating source exceeds the control reference temperature, the control unit controls the heating source to be repeatedly turned on and off for a predetermined time interval or predetermined times.

In another embodiment disclosed herein, there is provided a method for controlling a cooker. The method may include turning on a heating source if a current temperature of the heating source is higher than a predetermined first control reference temperature, repetitively turning on and off the heating source, and after repeatedly turning on and off the heating source, keeping the heating source in an on-state.

In a further embodiment disclosed herein, there is provided a method for controlling a cooker. The method may include turning on a heating source, repetitively turning on and off the heating source if a current temperature of the heating source is higher than a predetermined first control reference temperature, determining whether the current temperature of the heating source is higher than a predetermined second control reference temperature after repeatedly turning on and off the heating source, repetitively turning on and off the heating source for a predetermined time interval or period of time or a predetermined times or number of times if the current temperature of the heating source is higher than the second control reference temperature.

According to embodiments disclosed herein, food may be heated and cooked more safely.

Further, in the cooker and the method of controlling the cooker according to embodiments disclosed herein, the heating source may be controlled to be repeatedly turned on and off if the temperature of the heating source reaches a control reference temperature, so that the temperature of the heating source may be stably kept at a temperature equal to or lower than a rated temperature of the heating source. Therefore, objects such food may be heated by the heating source more safely.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A cooker, comprising:
a heating source configured to generate heat;
a temperature sensor configured to detect a temperature of the heating source; and
a controller configured to compare a current temperature of the heating source detected by the temperature sensor with at least one control reference temperature to control an on/off operation of the heating source, wherein until the current temperature of the heating source reaches the control reference temperature, the controller controls the heating source to be kept in an on-state, and when the current temperature of the heating source exceeds the control reference temperature, the controller controls the heating source to be repeatedly turned on and off for a predetermined period of time or for a predetermined number of times.

2. The cooker according to claim 1, wherein if the heating source is repeatedly turned on and off for longer than the predetermined period of time or more than the predetermined number of times, the controller controls the heating source to be kept in an on-state.

3. The cooker according to claim 1, wherein the heating source comprises a tube heater using a quartz tube.

4. The cooker according to claim 1, wherein the controller comprises:
an input device configured to receive an operational signal for operating the heating source;
a micom configured to control the heating source according to the operational signal received through the input device; and
a switch configured to be turned on and off by the micom to selectively supply power to the heating source.

5. The cooker according to claim 4, wherein the controller further comprises a switch driver configured to turn on and off the switch under the control of the micom.

6. A method for controlling a cooker, the method comprising:
turning on a heating source;
detecting a current temperature of the heating source;
if the detected current temperature of the heating source is higher than a predetermined first control reference temperature, repetitively turning on and off the heating source; and
after repeatedly turning on and off the heating source, keeping the heating source in an on-state.

7. The method according to claim 7, wherein the repetitive turning on and off of the heating source is performed for a predetermined period of time or for a predetermined number of times.

8. The method according to claim 6, wherein in the repetitive turning on and off of the heating source, the turning off of the heating source is performed if the detected current temperature of the heating source is higher than a predetermined off-operation reference temperature.

9. The method according to claim 6, wherein in the repetitive turning on and off of the heating source, the turning on of the heating source is performed if the detected current temperature of the heating source is lower than a predetermined on-operation reference temperature.

10. The method according to claim 6, wherein the keeping of the heating source in the on-state comprises comparing the detected current temperature of the heating source with a predetermined second control reference temperature.

11. The method according to claim 10, wherein if the detected current temperature of the heating source is higher than the second control reference temperature, the method further comprises controlling the heating source to be repetitively turned on and off.

12. The method according to claim 11, wherein after the controlling of the heating source by repetitively turning on and off the heating source, the method further comprises keeping the heating source in an on-state.

13. The method according to claim 6, wherein the repetitive turning on and off of the heating source and the keeping of the heating source in the on-state are repeated at least two times.

14. A method for controlling a cooker, comprising:
turning on a heating source;
detecting a current temperature of the heating source;
repetitively turning on and off the heating source if the detected current temperature of the heating source is higher than a predetermined first control reference temperature;
determining whether the detected current temperature of the heating source is higher than a predetermined second control reference temperature after repeatedly turning on and off the heating source; and
repetitively turning on and off the heating source for a predetermined period of time or for a predetermined number of times if the detected current temperature of the heating source is higher than the second control reference temperature.

15. The method according to claim 14, wherein each of the repetitively turning on and off of the heating source comprises keeping the heating source in an on-state after the heating source is repetitively turned on and off for the predetermined period of time or for the predetermined number of times.

16. The method according to claim 14, wherein in the first repetitively turning on and off, the turning off of the heating source is performed if the detected current temperature of the heating source is higher than a predetermined first off-operation reference temperature, and the turning on of the heating source is performed if the detected current temperature of the heating source is lower than a predetermined first on-operation reference temperature.

17. The method according to claim 16, wherein one of the first off-operation reference temperature and the first on-operation reference temperature is equal to the first control reference temperature.

18. The method according to claim 14, wherein in the second repetitively turning on and off, the turning off of the heating source is performed if the detected current temperature of the heating source is higher than a predetermined second off-operation reference temperature, and the turning on of the heating source is performed if the detected current temperature of the heating source is lower than a predetermined second on-operation reference temperature.

19. The method according to claim 14, wherein the second control reference temperature is equal to or lower than a rated temperature of the heating source.

20. The method according to claim 14, wherein the first control reference temperature is lower than the second control reference temperature.
